(19) United States
(12) Patent Application Publication
(10) Pub. No.: US 2020/0056056 A1
(43) Pub. Date: Feb. 20, 2020

(54) Hard Coating Film and Preparation Method Thereof

(71) Applicants: SK Innovation Co., Ltd., Seoul (KR); SK IE Technology Co., Ltd., Seoul (KR)

(72) Inventors: Jong Nam Ahn, Daejeon (KR); Byoung Sun Ko, Daejeon (KR); Jin Su Park, Daejeon (KR); Tae Sug Jang, Daejeon (KR); Ho Chul Yoon, Daejeon (KR)

(21) Appl. No.: 16/539,087

(22) Filed: Aug. 13, 2019

(30) Foreign Application Priority Data
Aug. 17, 2018 (KR) 10-2018-0096208
Aug. 5, 2019 (KR) 10-2019-0094767

(51) Int. Cl. C09D 5/16; C09D 163/00; C09D 183/06; C09D 7/63

(52) U.S. Cl. CPC C09D 5/1675; C09D 163/00; C08K 5/1515; C09D 183/06; C09D 7/63; C09D 5/1687

(57) ABSTRACT

Provided is an antifouling hard coating film including a cured layer of a composition for forming a hard coating layer including an epoxy siloxane resin, disposed on a substrate, and an antifouling layer including a fluorine-substituted silsesquioxane resin, disposed on the cured layer, the antifouling hard coating film having excellent interlayer bonding force, hardness, and antifouling property, and suppressed curling.

### CROSS-REFERENCE TO RELATED APPLICATIONS

This application claims priority to Korean Patent Application No. 10-2018-0096208 filed Aug. 17, 2018 and Korean Patent Application No. 10-2019-0094767 filed Aug. 5, 2019, the disclosures of which are hereby incorporated by reference in their entirety.

### TECHNICAL FIELD

The present invention relates to a hard coating film, and a preparation method thereof.

### BACKGROUND

Recently, thin displays using a flat panel display such as an organic light emitting diode display or a liquid crystal display are drawing attention. Particularly, these thin displays are implemented in the form of a touch screen panel and are widely used in various smart devices characterized by portability including various wearable devices as well as smart phones and tablet PCs.

These portable touch screen panel-based displays are provided with a window cover for display protection on a display panel for protecting the display panel from scratches or external impact, and in most cases, tempered glass for a display is used as a window cover. A tempered glass for a display is thinner than general glass, but is characterized by being manufactured to have high strength together with resistance to scratches.

However, the tempered glass has a disadvantage of being not suitable for weight reduction of portable devices due to its heavy weight, is vulnerable to external shock so that it is difficult to implement an unbreakable property, and does not bend above a certain level so that the tempered glass is unsuitable as a flexible display material having a bendable or foldable function.

Recently, various studies on an optical plastic cover securing flexibility and impact resistance simultaneously with having strength or scratch resistance corresponding to tempered glass have been conducted. In general, examples of optical transparent plastic cover materials having flexibility as compared with tempered glass may include polyethylene terephthalate (PET), polyether sulfone (PES), polyethylene naphthalate (PEN), polyacrylate (PAR), polycarbonate (PC), polyimide (PI), polyaramide (PA), polyamideimide (PAI), and the like. However, these polymer plastic substrates exhibit insufficient physical properties in terms of hardness and scratch resistance and also does not have sufficient impact resistance, as compared with tempered glass used as a window cover for display protection. Thus, various attempts for complementing the required physical properties by coating a composite resin composition on these plastic substrates, have been made. As an example, a plastic substrate disclosed in Korean Patent Laid-Open Publication No. 10-2013-0074167 is included.

In the case of a general hard coating, a composition including a resin containing a photocurable functional group such as (meth)acrylate or epoxy, a curing agent or a curing catalyst, and other additives is used, but it is difficult to implement high hardness corresponding to the tempered glass, a curling phenomenon occurs a lot due to shrinkage at the time of curing, and also flexibility is insufficient, and thus, the general hard coating has a disadvantage of being not appropriate as a protective window substrate for being applied to a flexible display.

### RELATED ART DOCUMENTS

Korean Patent Laid-Open Publication No. 10-2013-0074167

### SUMMARY

An embodiment of the present invention is directed to providing a hard coating film having improved mechanical properties, wear resistance, antifouling property, anti-curling property, and the like.

Another embodiment of the present invention is directed to providing a preparation method of a hard coating film having improved mechanical properties, wear resistance, antifouling property, anti-curling property, and the like.

In one general aspect, a hard coating film includes: a substrate; a cured layer of a composition for forming a hard coating layer including an epoxy siloxane resin, disposed on the substrate; and an antifouling layer including a fluorine-substituted silsesquioxane resin, disposed on the cured layer.

In some exemplary embodiments, the epoxy siloxane resin may include a silsesquioxane resin having an epoxy group.

In some exemplary embodiments, the composition for forming a hard coating layer may further include a thermal initiator including a compound represented by the following Chemical Formula 2 and a photoinitiator:

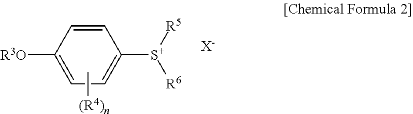

wherein R³ is hydrogen, an alkoxycarbonyl group having 1 to 4 carbon atoms, an alkylcarbonyl group having 1 to 4 carbon atoms, or an arylcarbonyl group having 6 to 14 carbon atoms, R⁴ is independently of each other hydrogen, halogen, or an alkyl group having 1 to 4 carbon atoms, n is 1 to 4, R⁵ is an alkyl group having 1 to 4 carbon atoms or an aralkyl group having 7 to carbon atoms which may be substituted by an alkyl group having 1 to 4 carbon atoms, R⁶ is an alkyl group having 1 to 4 carbon atoms, and X is SbF₆, PF₆, AsF₆, BF₄, CF₃SO₃, N(CF₃SO₂)₂, or N(C₆F₅)₄.

In some exemplary embodiments, the composition for forming a hard coating layer may further include a crosslinking agent including a compound represented by the following Chemical Formula 1:

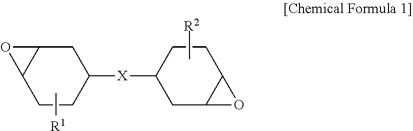

wherein R¹ and R² are independently of each other a linear or branched alkyl group having 1 to 5 carbon atoms, and X is a direct bond; a carbonyl group; a carbonate group; an ether group; a thioether group; an ester group; an amide group; a linear or branched alkylene group, alkylidene group, or alkoxylene group having 1 to 18 carbon atoms; a cycloalkylene group or cycloalkylidene group having 1 to 6 carbon atoms; or a connecting group thereof.

In some exemplary embodiments, the cured layer may be a complexly cured layer formed by photocuring and then thermally curing the composition for forming a hard coating layer.

In another general aspect, a preparation method of a hard coating film includes: applying a composition for forming a hard coating layer including an epoxy siloxane resin on a substrate; curing the applied composition for forming a hard coating layer to form a cured layer; applying a composition for forming an antifouling layer including a fluorine-substituted silsesquioxane resin on the cured layer; and curing the applied composition for forming an antifouling layer.

In some exemplary embodiments, the step of forming a cured layer may be photocuring and then thermally curing the composition for forming a hard coating layer.

In some exemplary embodiments, the thermal curing may be carried out at a temperature of 100 to 200° C. for 5 to 20 minutes.

In some exemplary embodiments, a step of pretreating the composition for forming a hard coating layer by heating may be further included before the photocuring.

In some exemplary embodiments, the pretreatment may be carried out at a lower temperature than a thermal curing temperature.

In some exemplary embodiments, the step of curing a composition for forming an antifouling layer may be thermally curing the composition for forming an antifouling layer at a temperature of 50 to 100° C. for 3 to 30 minutes.

In some exemplary embodiments, the epoxy siloxane resin may include a silsesquioxane resin having an epoxy group.

In some exemplary embodiments, the composition for forming a hard coating layer may further include a thermal initiator including a compound represented by the following Chemical Formula 2 and a photoinitiator:

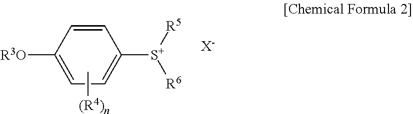

wherein R³ is hydrogen, an alkoxycarbonyl group having 1 to 4 carbon atoms, an alkylcarbonyl group having 1 to 4 carbon atoms, or an arylcarbonyl group having 6 to 14 carbon atoms, R⁴ is independently of each other hydrogen, halogen, or an alkyl group having 1 to 4 carbon atoms, n is 1 to 4, R⁵ is an alkyl group having 1 to 4 carbon atoms or an aralkyl group having 7 to carbon atoms which may be substituted by an alkyl group having 1 to 4 carbon atoms, R⁶ is an alkyl group having 1 to 4 carbon atoms, and X is SbF₆, PF₆, AsF₆, BF₄, CF₃SO₃, N(CF₃SO₂)₂, or N(C₆F₅)₄.

In some exemplary embodiments, the composition for forming a hard coating layer may further include a crosslinking agent including a compound represented by the following Chemical Formula 1:

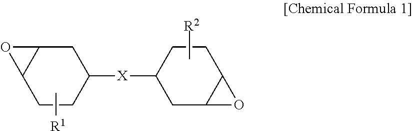

wherein R¹ and R² are independently of each other a linear or branched alkyl group having 1 to 5 carbon atoms, and X is a direct bond; a carbonyl group; a carbonate group; an ether group; a thioether group; an ester group; an amide group; a linear or branched alkylene group, alkylidene group, or alkoxylene group having 1 to 18 carbon atoms; a cycloalkylene group or cycloalkylidene group having 1 to 6 carbon atoms; or a connecting group thereof.

Other features and aspects will be apparent from the following detailed description, the drawings, and the claims.

### BRIEF DESCRIPTION OF THE DRAWINGS

FIG. 1 is schematic drawings illustrating a hard coating film according to the exemplary embodiments of the present invention.

FIGS. 2 and 3 are schematic flow charts representing a preparation method of a hard coating film according to the exemplary embodiments of the present invention.

### DETAILED DESCRIPTION OF MAIN ELEMENTS

10: Hard coating film
100: Substrate 110: Cured layer
120: Antifouling layer

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The exemplary embodiments of the present invention provide a hard coating film including a cured layer of a composition for forming a hard coating layer including an epoxy siloxane resin; and an antifouling layer including a fluorine-substituted silsesquioxane resin, and having excellent interlayer bonding force, hardness, and antifouling property, and suppressed curling. In addition, a preparation method of the hard coating film is provided.

Hereinafter, the exemplary embodiments of the present invention will be described in detail. However, these are only illustrative and the present invention is not limited to the specific embodiments which are illustratively described by the present invention.

The terms “curl” and “curling” used in the present specification mean bending deformation of a film, and “curl amount” means a vertical height from the lowest point of the film to a point where the film is bent to be raised when a curled film is placed on a flat surface.

The term, “anti-curling property” used herein may refer to a characteristic of less exhibiting the “curl amount”.

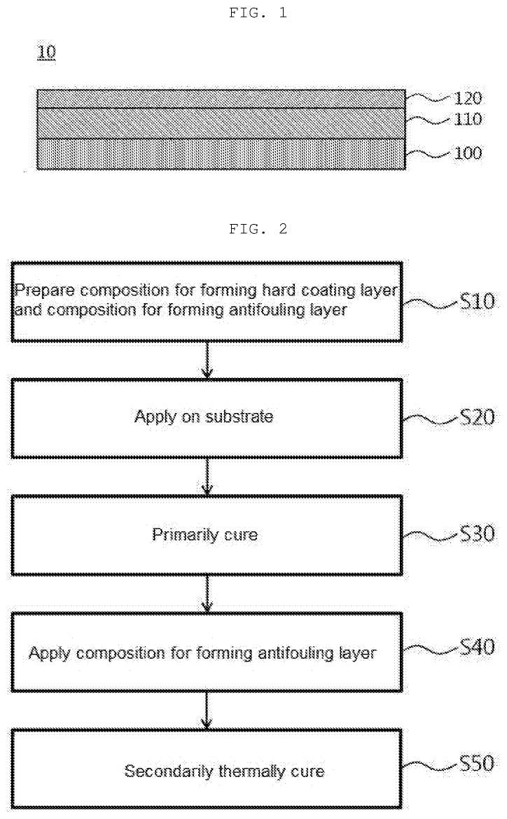

FIG. 1 is schematic drawings illustrating a hard coating film according to the exemplary embodiments of the present invention.

Referring to FIG. 1, the hard coating film 10 includes a substrate 100, a cured layer 110, and an antifouling layer 120.

The substrate 100, the cured layer 110, and the antifouling layer 120 may be laminated in order. In addition, each layer may be laminated directly in contact with each other, and another layer may be interposed between each layer.

It is preferred that the substrate 100 has excellent transparency, mechanical strength, thermal stability, moisture shielding property, isotropy, and the like. The substrate 100 may be manufactured from, for example, polyester-based resins such as polyethylene terephthalate, polyethylene isophthalate, and polybutylene terephthalate; cellulose-based resins such as diacetyl cellulose and triacetyl cellulose; polycarbonate-based resins; acrylic resins such as polymethyl (meth)acrylate and polyethyl (meth)acrylate; styrene-based resins such as a polystyrene acrylonitrile-styrene copolymer; polyolefin-based resin having a polyethylene, polypropylene, cyclo-based or norbornene structure, polyolefin-based resins such as an ethylenepropylene copolymer; polyimide-based resins; polyaramide-based resins; polyamideimide-based resins; polyethersulfone-based resins; sulfone-based resins, and the like. These resins may be used alone or in combination of two or more.

The thickness of the substrate 100 is not particularly limited, and for example, may be 10 to 250 μm.

The cured layer 110 is disposed on the substrate 100. The cured layer 110 may be formed by curing the composition for forming a hard coating layer.

In some exemplary embodiments, the cured layer 110 may be a complexly cured layer formed by photocuring and then thermally curing the composition for forming a hard coating layer.

In the present invention, the composition for forming a hard coating layer may include an epoxy siloxane resin. The epoxy siloxane resin may have excellent hardness and curl property when cured.

The epoxy siloxane resin may be for example, a siloxane resin including an epoxy group. The epoxy group may be any one or more selected from the group consisting of a cyclic epoxy group, an aliphatic epoxy group, and an aromatic epoxy group. The siloxane resin may refer to a polymer compound in which a silicon atom and an oxygen atom form a covalent bond. When the cured layer including the epoxy siloxane resin is formed and the antifouling layer including the fluorine-substituted silsesquioxane resin is formed on the cured layer, the bonding force between the cured layer and the antifouling layer may be improved, due to the similar chemical structure of the epoxy siloxane resin and the fluorine-substituted silsesquioxane resin.

In some exemplary embodiments, the epoxy siloxane resin may be an epoxy group-substituted silsesquioxane resin. For example, the epoxy siloxane resin may be that in which the silicon atom of the silsesquioxane resin is directly substituted by an epoxy group or the substituent on the silicon atom is substituted by an epoxy group. As a non-limiting example, the epoxy siloxane resin may be a silsesquioxane resin substituted by a 2-(3,4-epoxycyclohexyl)ethyl group. In this case, since the epoxy siloxane resin may have a more similar molecular structure to the fluorine-substituted silsesquioxane resin, the bonding force between the cured layer and the antifouling layer may be more improved.

According to some exemplary embodiments, the epoxy siloxane resin may have a weight average molecular weight of 1,000 to 20,000, more preferably 1,000 to 18,000, and more preferably 2,000 to 15,000. When the weight average molecular weight is within the above range, the composition for forming a hard coating layer may have more proper density. Thus, the flowability, coatability, curing reactivity, and the like of the composition for forming a hard coating layer may be further improved. In addition, the hardness of the cured layer may be further improved and flexibility is improved, thereby further suppressing occurrence of curling.

The epoxy siloxane resin according to the present invention may be prepared by hydrolysis and a condensation reaction of alkoxysilane having an epoxy group alone or between alkoxysilane having an epoxy group and another kind of alkoxysilane, in the presence of water.

According to exemplary embodiments, alkoxysilane having the epoxy group used in the preparation of the epoxy siloxane resin may be exemplified by the following Chemical Formula 3:

R⁷ₙSi(OR⁸)₄₋ₙ [Chemical Formula 3]

wherein R⁷ is an epoxycycloalkyl group having 3 to 6 carbon atoms or a linear or branched alkyl group having 1 to 6 carbon atoms substituted by an oxiranyl group, in which the alkyl group may include an ether group, R⁸ is a linear or branched alkyl group having 1 to 7 carbon atoms, and n is an integer of 1 to 3.

The alkoxysilane represented by the above Chemical Formula 3 is not particularly limited, and examples thereof may include 2-(3,4-epoxycyclohexyl)ethyltrimethoxysilane, 2-(3,4-epoxycyclohexyl)ethyltriethoxysilane, 3-glycidoxypropyltrimethoxysilane, and the like. These may be used alone or in combination of two or more.

In some exemplary embodiments, the epoxy siloxane resin may be included at 20 to 70 parts by weight, based on 100 parts by weight of the entire composition. More preferably, the epoxy siloxane resin may be included at 20 to 50 parts by weight, based on 100 parts by weight of the entire composition. When the above range is satisfied, the composition for forming a hard coating layer may secure better flowability and coating property. In addition, uniform curing is possible at the time of curing the composition for forming a hard coating layer to more effectively prevent physical defects such as cracks due to overcuring. In addition, the cured layer may exhibit better hardness.

According to exemplary embodiments, the composition for forming a hard coating layer may further include a thermal initiator including a compound represented by the following Chemical Formula 2 and a photoinitiator:

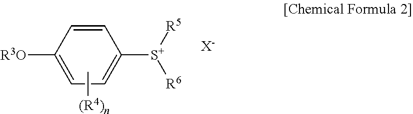

wherein R³ is hydrogen, an alkoxycarbonyl group having 1 to 4 carbon atoms, an alkylcarbonyl group having 1 to 4 carbon atoms, or an arylcarbonyl group having 6 to 14 carbon atoms, R⁴ is independently of each other hydrogen, halogen, or an alkyl group having 1 to 4 carbon atoms, n is 1 to 4, R⁵ is an alkyl group having 1 to 4 carbon atoms or an aralkyl group having 7 to carbon atoms which may be substituted by an alkyl group having 1 to 4 carbon atoms, R⁶ is an alkyl group having 1 to 4 carbon atoms, and X is SbF₆, PF₆, AsF₆, BF₄, CF₃SO₃, N(CF₃SO₂)₂, or N(C₆F₅)₄.

The alkoxy portion of the alkoxycarbonyl group has 1 to 4 carbon atoms, and examples of the alkoxycarbonyl group may include a methoxycarbonyl group, an ethoxycarbonyl group, a propoxycarbonyl group, and the like.

The alkyl portion of the alkylcarbonyl group has 1 to 4 carbon atoms, and examples of the alkylcarbonyl group may include an acetyl group, a propionyl group, and the like.

The aryl portion of the arylcarbonyl group has 6 to 14 carbon atoms, and examples of the arylcarbonyl group may include a benzoyl group, a 1-naphthylcarbonyl group, a 2-naphthylcarbonyl group, and the like.

Examples of the aralkyl group may include a benzyl group, a 2-phenylethyl group, a 1-naphthylmethyl group, a 2-naphthylmethyl group, and the like.

When the compound of the following Chemical Formula 2 is used as the thermal initiator, the curing half-life may be shortened. Accordingly, the thermal curing may be performed rapidly even under the low-temperature conditions, thereby preventing damage and deformation which occur in the case of long-term heat treatment under the high-temperature conditions.

The thermal initiator may promote the crosslinking reaction of the epoxy siloxane resin or the crosslinking agent described later when heat is applied to the composition for forming a hard coating layer. As the thermal initiator, a cationic thermal initiator may be used, but not limited thereto.

In addition, photocuring using the photoinitiator is used in combination with the thermal curing using the thermal initiator, thereby improving a curing degree, hardness, flexibility, and the like of the cured layer and decreasing curls.

For example, the composition for forming a hard coating layer is applied to a substrate or the like and is irradiated with ultraviolet rays (photocuring) to at least partially cure the composition, and then heat is further applied (thermal curing) to substantially completely cure the composition.

That is, the composition for forming a hard coating layer may be semi-cured or partially cured by the photocuring, and the semi-cured or partially cured composition for forming a hard coating layer may be substantially completely cured by the thermal curing.

For example, when the composition for forming a hard coating layer is cured only by photocuring, a curing time is excessively extended, or in part, curing may not be completely performed. However, when the photocuring is followed by the thermal curing, the portion which is not cured by the photocuring may be substantially completely cured by the thermal curing, and the curing time may be also reduced.

In addition, generally, a portion which is appropriately cured is provided with excessive energy due to an increase in the curing time (for example, an increase in light exposure time), so that overcuring may occur. When the overcuring proceeds, the cured layer may lose flexibility or mechanical defects such as curls or cracks may occur. However, when the photocuring and the thermal curing are used in combination, the composition for forming a hard coating layer may be substantially completely cured within a short time. Thus, the hardness may be improved and occurrence of curling may be suppressed, while the flexibility of the cured layer is maintained.

Though the method of first photocuring the composition for forming a hard coating layer and further thermally curing the composition has been described above, the sequence of the photocuring and the thermal curing is not particularly limited thereto. That is, in some exemplary embodiments, the thermal curing may first proceed and then the photocuring may proceed, of course.

In some exemplary embodiments, the thermal initiator may be included at 0.1 to 20 parts by weight, and more preferably 1 to 20 parts by weight, based on 100 parts by weight of the epoxy siloxane resin. When the content of the thermal initiator is within the above range, the thermal curing may proceed at a more effective speed, and the contents of other components of the composition for forming a hard coating layer are decreased to prevent the mechanical properties (for example, hardness, flexibility, a curling property, and the like) of the cured layer from being deteriorated.

In addition, for example, the thermal initiator may be included at 0.01 to 15 parts by weight, based on 100 parts by weight of the entire composition. More preferably, the photoinitiator may be included at 0.1 to 15 parts by weight, and still more preferably 0.3 to 10 parts by weight, based on 100 parts by weight of the entire composition.

According to some exemplary embodiments, the photoinitiator may include a photo-cationic initiator. The photo-cationic initiator may initiate polymerization of the epoxy siloxane resin and an epoxy-based monomer.

As the photo-cationic initiator for example, an onium salt and/or organic metal salt may be used, but not limited thereto. For example, a diaryliodonium salt, a triarylsulfonium salt, an aryldiazonium salt, an iron-arene complex, and the like may be used. These may be used alone or in combination of two or more.

The content of the photoinitiator is not particularly limited, but for example, the photoinitiator may be included at 0.1 to 15 parts by weight, and more preferably 1 to 15 parts by weight, based on 100 parts by weight of the epoxy siloxane resin. When the content of the photoinitiator is within the above range, better curing efficiency of the composition for forming a hard coating layer may be maintained, and deterioration of the physical properties due to residual components after curing may be prevented.

In addition, for example, the photoinitiator may be included at 0.01 to 10 parts by weight, based on 100 parts by weight of the entire composition. More preferably, the photoinitiator may be included at 0.1 to 10 parts by weight, and still more preferably 0.3 to 5 parts by weight, based on 100 parts by weight of the entire composition.

In some exemplary embodiments, the composition for forming a hard coating layer may further include a crosslinking agent. The crosslinking agent may form crosslinks with the epoxy siloxane resin to solidify the composition for forming a hard coating layer and improve the hardness of the cured layer.

According to exemplary embodiments, the crosslinking agent may include a compound having an alicyclic epoxy group. For example, the crosslinking agent may include a compound in which two 3,4-epoxycyclohexyl groups are connected. For example, the crosslinking agent may include a compound represented by the following Chemical Formula 1. The crosslinking agent may have similar structure and characteristics to the epoxy siloxane resin. In this case, the crosslinking of the epoxy siloxane resin is promoted and the composition may be maintained at a proper density.

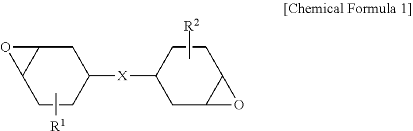

wherein R¹ and R² are independently of each other a linear or branched alkyl group having 1 to 5 carbon atoms, and X is a direct bond; a carbonyl group; a carbonate group; an ether group; a thioether group; an ester group; an amide group; a linear or branched alkylene group, alkylidene group, or alkoxylene group having 1 to 18 carbon atoms; a cycloalkylene group or cycloalkylidene group having 1 to 6 carbon atoms; or a connecting group thereof.

In the present specification, a “direct bond” refers to a structure which is directly bonded without any functional group, and for example, in Chemical Formula 1, refers to two cyclohexanes directly connected to each other. In addition, in the present invention, a “connecting group” refers to two or more substituents described above being connected to each other.

In addition, in Chemical Formula 1, the substitution positions of R¹ and R² are not particularly limited, but when the carbon connected to X is set at position 1, and the carbons connected to an epoxy group are set at positions 3 and 4, it is preferred that R¹ and R² are substituted at position 6.

The compound described above includes a cyclic epoxy structure in the molecule, and when the epoxy structure is formed in a linear shape as in Chemical Formula 1, the viscosity of the composition may be lowered to an appropriate range. When the viscosity is lowered, the coatability of the composition is improved and also the reactivity of the epoxy group is further improved, thereby promoting the curing reaction. In addition, crosslinks with the epoxy siloxane resin may be formed to improve the hardness of the cured layer.

The content of the crosslinking agent according to the present invention is not particularly limited, and for example, may be 5 to 150 parts by weight, based on 100 parts by weight of the epoxy siloxane resin. When the content of the crosslinking agent is within the above range, the viscosity of the composition may be maintained in an appropriate range, and coatability and curing reactivity may be improved.

In addition, the crosslinking agent may be included at 1 to 30 parts by weight, based on 100 parts by weight of the entire composition. More preferably, the crosslinking agent may be included at 5 to 20 parts by weight, based on 100 parts by weight of the entire composition.

According to the exemplary embodiments, the composition for forming a hard coating layer may further include a thermal curing agent.

The thermal curing agent may include an amine-based curing agent, an imidazole-based curing agent, an acid anhydride-based curing agent, an amide-based thermal curing agents, and the like, and in terms of discoloration prevention and high hardness implementation, it is more preferred to further use an acid anhydride-based thermal curing agent. These may be used alone or in combination of two or more.

The content of the thermal curing agent is not particularly limited, and for example, may be 5 to 30 parts by weight, based on 100 parts by weight of the epoxy siloxane resin. When the content of the thermal curing agent is within the above range, the hardness efficiency of the composition for forming a hard coating layer may be further improved to form a cured layer having excellent hardness.

In some exemplary embodiments, the composition for forming a hard coating layer may further include a solvent. The solvent is not particularly limited and a solvent known in the art may be used.

Non-limiting examples of the solvent may include alcohol-based solvents (such as methanol, ethanol, isopropanol, butanol, methyl cellosolve, and ethyl cellosolve), ketone-based solvents (such as methyl ethyl ketone, methyl butyl ketone, methyl isobutyl ketone, diethyl ketone, dipropyl ketone, and cyclohexanone), hexane-based solvents (such as hexane, heptane, and octane), benzene-based solvents (such as benzene, toluene, and xylene), and the like. These may be used alone or in combination of two or more.

The content of the solvent is not particularly limited, and for example, may be 10 to 200 parts by weight, based on 100 parts by weight of the epoxy siloxane resin. When the above range is satisfied, the composition for forming a hard coating layer may secure an appropriate level of viscosity, and workability at the time of forming the cured layer may be better. In addition, it is easy to control the thickness of the cured layer, and the solvent drying time is reduced to secure a rapid process speed.

According to some exemplary embodiments, the solvent may be included at a residual amount excluding the amount of the remaining components in the total weight of the predetermined entire composition. For example, when the total weight of the predetermined entire composition is 100 g and the sum of the weights of the remaining components excluding the solvent is 70 g, 30 g of the solvent may be included.

In some exemplary embodiments, the composition for forming a hard coating layer may further include an inorganic filler. The inorganic filler may improve the hardness of the cured layer.

The inorganic filler is not particularly limited, and examples thereof may include metal oxides such as silica, alumina, and titanium oxide; hydroxides such as aluminum hydroxide, magnesium hydroxide, and potassium hydroxide; metal particles such as gold, silver, copper, nickel, and an alloy thereof; conductive particles such as carbon, carbon nanotubes, and fullerene; glass; ceramic; and the like. Preferably, silica may be used in terms of compatibility with other components of the composition. These may be used alone or in combination of two or more.

In some exemplary embodiments, the composition for forming a hard coating layer may further include a lubricant. The lubricant may improve winding efficiency, blocking resistance, wear resistance, scratch resistance, and the like.

The kind of the lubricants is not particularly limited, and for example, waxes such as polyethylene wax, paraffin wax, synthetic wax, or montan wax; synthetic resins such as a silicone-based resin or a fluorine-based resin; and the like may be used. These may be used alone or in combination of two or more.

In addition, the composition for forming a hard coating layer may further include additives such as, for example, an antioxidant, a UV absorber, a photostabilizer, a thermal polymerization inhibitor, a leveling agent, a surfactant, a lubricant, and an antifouling agent.

The thickness of the cured layer 110 is not particularly limited, and for example, may be 5 to 100 μm, and more preferably 5 to 50 μm. When the thickness of the cured layer 110 is within the range, the cured layer may have excellent hardness, maintain flexibility, and does not substantially produce curling.

According to some exemplary embodiments, the cured layer 110 may be formed on both surfaces of the substrate 100, or the cured layer 110 may be formed only one surface of the substrate 100.

The antifouling layer 120 is disposed on the cured layer 110. For example, the antifouling layer 120 may be disposed in contact with an upper surface of the cured layer 110.

The antifouling layer 120 may include a fluorine-substituted silsesquioxane resin. The fluorine-substituted silsesquioxane resin is a silsesquioxane resin substituted by fluorine, and for example, a silsesquioxane resin in which a silicon atom is substituted directly by fluorine, or a substituent on the silicon atom (for example, an alkyl group) and the like is substituted by fluorine. That is, the silicon atom may be connected to an alkyl group substituted by fluorine.

The fluorine-substituted silsesquioxane resin may impart excellent water-repellent, water proof, and oil-repellent performances to the antifouling layer. Accordingly, the antifouling layer prepared using the fluorine-substituted silsesquioxane resin may exhibit an excellent antifouling property.

Therefore, the antifouling layer 120 may have a water contact angle of 100° or more. In addition, the antifouling layer 120 may have excellent hardness, fraction resistance, and anti-curling property.

In addition, a silsesquioxane skeleton of the fluorine-substituted silsesquioxane resin may have a similar structure to a skeleton of the epoxy siloxane resin (for example, a silsesquioxane resin substituted by an epoxy group). Accordingly, the bonding force between the antifouling layer and the cured layer may be improved by the chemical bond between the fluorine-substituted silsesquioxane resin and the epoxy siloxane resin.

In some exemplary embodiments, the fluorine-substituted silsesquioxane resin may be synthesized by three-dimensional polymerization of the fluorine-substituted silane compound.

The fluorine-substituted silsesquioxane resin may include, for example, a silsesquioxane resin substituted by 1H,1H,2H,2H-perfluorodecyl group.

In some exemplary embodiments, the fluorine-substituted silsesquioxane resin may have a weight average molecular weight of 500 to 20000.

In some exemplary embodiments, the curing layer 110 and the antifouling layer 120 may be substantially integrated by the chemical bond between the fluorine-substituted silsesquioxane resin and the epoxy siloxane resin. Accordingly, a curling phenomenon occurring by a difference in shrinkage, an expansion rate, or a modulus of elasticity of different layers may be further suppressed.

In the present invention, the anti-curling property may refer to a significantly reduced curl amount. The curl amount may refer to a vertical height from the lowest position (for example, a center) to the vertex of the film, for each vertex of the sample cut into a square which is inclined at an angle of 45° to the MD direction and has each side of 10 cm in length.

In the present specification, the MD direction is a machine direction, and refers to a direction in which the film moves along an automated machine when the film is drawn or laminated by an automation process. As the curl is measured for the sample inclined at the angle of 45° to the MD direction, the curls at each vertex means curls to the MD direction and a direction perpendicular to the MD direction, thereby distinguishing the curls.

In some exemplary embodiments, the hard coating film 10 may exhibit the curl amount of 5 mm or less.

In some exemplary embodiments, the antifouling layer 120 of the hard coating film 10 may have a water contact angle of 100° or more.

In some exemplary embodiments, five or fewer flaws may be observed on a surface of the antifouling layer 120 of the hard coating film 10 after rubbing the surface 2000 times reciprocatively by applying a load of 0.5 kg with steel wool.

In addition, the present invention provides a preparation method of the hard coating film of the present invention described above.

The preparation method of a hard coating film according to the exemplary embodiments of the present invention includes: applying a composition for forming a hard coating layer including an epoxy siloxane resin on a substrate; curing the applied composition for forming a hard coating layer to form a cured layer; applying a composition for forming an antifouling layer including a fluorine-substituted silsesquioxane resin on the cured layer; and curing the applied composition for forming an antifouling layer.

In some exemplary embodiments, the step of forming a cured layer may be photocuring and then thermally curing the composition for forming a hard coating layer.

In some exemplary embodiments, the thermal curing may be carried out at a temperature of 100 to 200° C. for 5 to 20 minutes.

In some exemplary embodiments, a step of pretreating the composition for forming a hard coating layer by heating may be further included before the photocuring.

In some exemplary embodiments, the pretreatment may be carried out at a lower temperature than a thermal curing temperature.

In some exemplary embodiments, the step of curing a composition for forming an antifouling layer may be thermally curing the composition for forming an antifouling layer at a temperature of 50 to 100° C. for 3 to 30 minutes.

In the preparation method of a hard coating film of the present invention, the substrate, the epoxy siloxane resin, the composition for forming a hard coating layer, and the fluorine-substituted silsesquioxane resin may be those as described above, and thus, the specific descriptions thereof will be omitted herein.

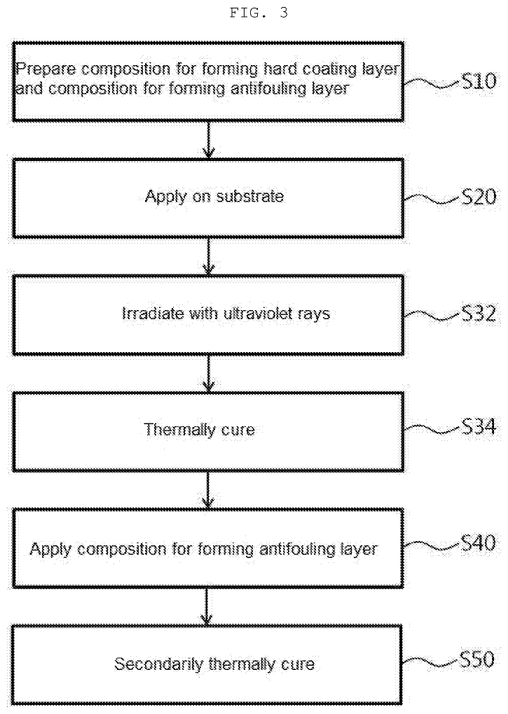

Hereinafter, referring to FIGS. 2 and 3, a preparation method of a hard coating film according to the exemplary embodiments of the present invention will be described in detail.

FIGS. 2 and 3 are schematic flow charts representing a preparation method of a hard coating film according to the exemplary embodiments of the present invention.

In exemplary embodiments, a composition for forming a hard coating layer may be prepared (for example, S10). As the composition for forming a hard coating layer, the composition for forming a hard coating layer according to the above-described exemplary embodiments of the present invention may be used.

Then, the composition for forming an antifouling layer may be prepared. Preparation of the composition for forming an antifouling layer may be carried out simultaneously with preparation of the composition for forming a hard coating layer (for example, S10), or may proceed in a separate order.

The composition for forming an antifouling layer includes a fluorine-substituted silsesquioxane resin.

In some exemplary embodiments, the composition for forming an antifouling layer may include a solvent. The solvent may include, for example, hexafluoroxylene, hydrofluorocarbon, or hydrofluoroether, and as a commercially available product, Vertrel XF (CF₃CHFCHFCF₂CF₃) manufactured by DuPont, ZEORORA H (heptafluorocyclopentane) manufactured by Nihon Zeon Corporation, HFE-7100 (C₄F₉OCH₃) and 7200 (C₄F₉OC₂H₅) manufactured by 3M Corporation, and the like.

For example, the composition for forming an antifouling layer may be prepared by mixing the fluorine-substituted silsesquioxane resin with the solvent.

In exemplary embodiments, the prepared composition for forming a hard coating layer may be applied on a substrate 100 (for example, S20).

The application (for example, S20) may be carried out by a die coater, an air knife, a reverse roll, spray, a blade, casting, gravure, spin coating, and the like.

According to some exemplary embodiments, the applied composition for forming a hard coating layer may be primarily cured (for example, S30). The curing may be carried out by photocuring or thermal curing, and the composition for forming a hard coating layer may be cured to form a cured layer having excellent hardness and suppressed curling.

In exemplary embodiments, the primary curing may be carried out by irradiating the applied composition for forming a hard coating layer with ultraviolet rays (for example, S32), and performing primary thermal curing (for example, S34).

In some exemplary embodiments, the composition for forming a hard coating layer may be at least partially photocured by the ultraviolet irradiation.

In exemplary embodiments, the ultraviolet irradiation may be carried out so that a curing degree of the composition for forming a hard coating layer is about 20 to 80%. When the curing degree is within the range, the cured layer is primarily cured to secure hardness, and simultaneously prevents an overcuring phenomenon due to an extended light exposure time.

For example, the ultraviolet irradiation may be carried out so that a pencil hardness of the cured layer is 1H or less. That is, the ultraviolet irradiation is finished before the pencil hardness of the cured layer becomes about 1H, and the primary thermal curing may be carried out.

In the primary thermal curing, for example, heat is applied to the cured layer composition which has been primarily partially cured by ultraviolet irradiation to substantially completely cure the composition. When the photocuring and the thermal curing having different curing mechanisms are used in combination, the curing time is shortened as compared with the case in which the photocuring or the thermal curing is carried out alone, thereby suppressing the overcuring phenomenon. In addition, the crosslinking reaction is effectively derived to allow the crosslinks to be uniformly formed.

In some exemplary embodiments, a compound of Chemical Formula 2 may be used as the thermal initiator. In this case, the curing half-life may be shortened. Thus, the thermal curing may be carried out rapidly even under the low-temperature conditions, thereby preventing deteriorated physical properties, damage and deformation of the cured layer which occur in the case of long-term heat treatment under the high-temperature conditions.

That is, the hardness of the cured layer 110 is improved, while flexibility is maintained. In addition, curling of the hard coating film 10 may be significantly decreased.

In some exemplary embodiments, the primary thermal curing may be carried out at a temperature of 100 to 200° C. for 5 to 20 minutes. More preferably the primary thermal curing may be carried out at a temperature of 120 to 180° C. Within the temperature range, the thermal curing may proceed at a more effective speed. In addition, thermal decomposition or causing a side reaction of each component in the composition for forming a hard coating layer, or occurrence of cracks due to overcuring of the cured layer may be effectively prevented.

According to exemplary embodiments, pretreatment may be carried out by heating the composition for forming a hard coating layer before ultraviolet irradiation. During the pretreatment process, a highly volatile solvent may be evaporated before ultraviolet irradiation, and thus, occurrence of bubbles and uneven curing during ultraviolet irradiation may be prevented.

The pretreatment may be carried out at lower temperature than the primary thermal curing temperature, and for example, carried out at 40 to 80° C. Within the temperature range, the solvent may be effectively evaporated while the initiation reaction of the thermal initiator does not occur.

According to exemplary embodiments, the prepared composition for forming an antifouling layer is applied on the cured layer 110 (for example, S40).

The application (for example, S40) may be carried out by a die coater, an air knife, a reverse roll, spray, a blade, casting, gravure, spin coating, and the like.

According to exemplary embodiments, the applied composition for forming an antifouling layer may be secondarily thermally cured to form an antifouling layer 120 (for example, S50). When the curing of the antifouling layer 120 is carried out not by photocuring but by thermal curing, the cured layer 110 on a lower surface of the antifouling layer 120 is prevented from being exposed to active energy rays (for example, ultraviolet rays) again. Accordingly, the curing-completed cured layer 110 is exposed to light again to prevent occurrence of overcuring or yellowing.

In the secondary thermal curing process, a chemical bond between the fluorine-substituted silsesquioxane resin and the epoxy siloxane resin may occur, and the bonding force between the antifouling layer 120 and the cured layer 110 may be further improved.

In some exemplary embodiments, the secondary thermal curing may be carried out at a temperature of 50 to 100° C. for 3 to 30 minutes, and more preferably 5 to 30 minutes. Within the temperature range, the composition for forming an antifouling layer may be cured at a more effective speed, and a side reaction may be effectively prevented from occurring between each component in the composition. More preferably, the secondary thermal curing may be carried out at a temperature of 70 to 90° C.

According to some exemplary embodiments, the primary thermal curing and the secondary thermal curing may be carried out simultaneously. For example, the composition for forming a hard coating layer is irradiated with ultraviolet rays to semi-cure the composition, the composition for forming an antifouling layer is applied, and the composition for forming a hard coating layer and the composition for forming an antifouling layer may be cured by one thermal curing. In this case, the thermal curing may be carried out at a temperature of 90 to 140° C. The composition for forming an antifouling layer is applied before the composition for forming a hard coating layer is completely cured and the two compositions are cured together, thereby promoting formation of a chemical bond between the fluorine-substituted silsesquioxane resin and the epoxy siloxane resin in an interface of the antifouling layer 120 and the cured layer 110.

In some exemplary embodiments, the hard coating film 10 has a high surface hardness, excellent flexibility, and excellent impact resistance as compared with tempered glass, and thus, may be preferably used as a window substrate of the outermost surface of the display panel.

According to some exemplary embodiments, an image display including the hard coating film 10 may be provided.

The hard coating film 10 may be used as the outermost surface window substrate of the image display. The image display may be various image displays such as a common liquid crystal display, an electroluminescence display, a plasma display, and a field emission display.

Hereinafter, preferred examples will be provided in order to assist in the understanding of the present invention. However, it will be obvious to those skilled in the art that these examples only illustrate the present invention and do not limit the appended claims, and various modifications and alterations of the examples may be made within the range of the scope and spirit of the present invention, and these modifications and alterations will fall within the appended claims.

### Preparation Example 1

2-(3,4-Epoxycyclohexyl)ethyltrimethoxysilane (ECTMS, TCI Co., Ltd.) and water (H₂O, Sigma-Aldrich Corporation) were mixed at a ratio of 24.64 g:2.70 g (0.1 mol:0.15 mol) and placed in a 250 mL 2-neck flask. Thereafter, 0.1 mL of a tetramethylammonium hydroxide catalyst (Sigma-Aldrich) and 100 mL of tetrahydrofuran (Sigma-Aldrich) were added to the mixture and stirred at 25° C. for 36 hours. Then, layer separation was performed and a product layer was extracted with methylene chloride (Sigma-Aldrich), and moisture was removed from the extract with magnesium sulfate (Sigma-Aldrich) and the solvent was dried under vacuum to obtain an epoxy siloxane resin. As a result of measuring the epoxy siloxane resin using gel permeation chromatography (GPC), the weight average molecular weight was 2500.

### Preparation Example 2

1H,1H,2H,2H-perfluorodecyltrimethoxysilane (PFDS, TCI Co., Ltd) and water (H₂O, Sigma-Aldrich Corporation) were mixed at a ratio of 24.64 g:2.70 g (0.1 mol:0.15 mol) and placed in a 250 mL 2-neck flask. Thereafter, 0.1 mL of a tetramethylammonium hydroxide catalyst (Sigma-Aldrich) and 100 mL of tetrahydrofuran (Sigma-Aldrich) were added to the mixture and stirred at 25° C. for 72 hours. Then, layer separation was performed and a product layer was extracted with methylene chloride (Sigma-Aldrich), and moisture was removed from the extract with magnesium sulfate (Sigma-Aldrich) and the solvent was dried under vacuum to obtain a fluorine-substituted silsesquioxane resin. As a result of measuring the fluorine-substituted silsesquioxane resin using GPC, the weight average molecular weight was 8000.

### Example 1

30 parts by weight of the epoxy siloxane resin prepared in Preparation Example 1, 15 parts by weight of (3′,4′-epoxycyclohexyl)methyl 3,4-epoxycyclohexanecarboxylate (Daicel Corporation, Celloxide 2021P), 1 part by weight of 4-acetoxyphenyldimethylsulfonium hexafluoroantimonate (SANSHIN CHEMICAL INDUSTRY CO., LTD., SI-60), 1 part by weight of (4-methylphenyl) [4-(2-methylpropyl)phenyl]iodonium hexafluorophosphate, and 53 parts by weight of methyl ethyl ketone (Sigma-Aldrich) were mixed to prepare a composition for forming a hard coating layer.

The fluorine-substituted silsesquioxane resin prepared in Preparation Example 2 was diluted in hexafluoroxylene so that a solid content is 5% by weight to prepare a composition for forming an antifouling layer.

Step of Forming Cured Layer

The composition for forming a hard coating layer was applied on a colorless polyimide (cPI) film having a thickness of 80 μm by a Meyer bar method, and was allowed to stand at a temperature of 60° C. for 5 minutes. UV was irradiated at 1 J/cm² using a high-pressure metal lamp and then curing was performed at a temperature of 120° C. for 15 minutes to prepare a cured layer having a thickness of 10 μm.

Step of Forming Antifouling Layer

The composition for forming an antifouling layer was applied on the cured layer with a Meyer bar, and was thermally cured at a temperature of about 80° C. for about 20 minutes to prepare a hard coating film on which an antifouling layer (a thickness of 300 nm) is formed.

### Example 2

A hard coating film was prepared in the same manner as in Example 1, except that in the formation of the cured layer of Example 1, a composition in which 30 parts by weight of the epoxy siloxane resin (Polyset Company, epoxy equivalent of 20,000 g/mol, PC-2000), 15 parts by weight of (3′,4′-epoxycyclohexyl)methyl 3,4-epoxycyclohexanecarboxylate (Daicel Corporation, Celloxide 2021P), 1 part by weight of 4-acetoxyphenyldimethylsulfonium hexafluoroantimonate (SANSHIN CHEMICAL INDUSTRY CO., LTD., SI-60), 1 part by weight of (4-methylphenyl) [4-(2-methylpropyl)phenyl]iodonium hexafluorophosphate, and 53 parts by weight of methyl ethyl ketone (Sigma-Aldrich) were mixed, was used as the composition for forming a hard coating layer.

### Comparative Example 1

40 parts by weight of pentaerythritol tetraacrylate, 1 part by weight of 1-hydroxycyclohexyl phenyl ketone, and 59 parts by weight of methyl ethyl ketone (Sigma-Aldrich) were mixed to prepare a hard coating composition of the Comparative Example.

99 parts by weight of fluorine acrylate (Megaface RS75, solid content of 10% by weight) and 1 part by weight of 1-hydroxycyclohexyl phenyl ketone were mixed to prepare an antifouling coating composition of the Comparative Example.

Step of Forming Cured Layer

The hard coating composition was applied on a cPI film having a thickness of 80 μm by a Meyer bar method, and was allowed to stand at a temperature of 60° C. for 5 minutes. UV was irradiated at 1 J/cm² using a high pressure metal lamp to form a cured layer having a thickness of 10 μm.

Step of Forming Antifouling Layer

The antifouling coating composition was applied on the cured layer with a Meyer bar, was allowed to stand at a temperature of about 60° C. for 5 minutes, and then UV was irradiated at 1 J/cm² using a high pressure metal lamp to prepare a hard coating film on which an antifouling layer is formed (thickness of 300 nm).

### Comparative Example 2

A hard coating film was prepared by identically carrying out the cured layer formation step of Example 1, and then identically carrying out the antifouling layer formation step of Comparative Example 1.

### Comparative Example 3

A hard coating film was prepared by identically carrying out the cured layer formation step of Comparative Example 1, and then identically carrying out the antifouling layer formation step of Example 1.

### Experimental Example

The curl amount, the water contact angle, and the wear resistance of the hard coating films of the Examples and the Comparative Example were evaluated.

1. Measurement of Curl Amount

A hard coating film was cut into a square of 10 cm×10 cm inclined at an angle of 45° to an MD direction and allowed to stand at 25° C., 50% under constant temperature and humidity conditions, and then the curling degree of each vertex was measured using a ruler. The measured curl amount is shown in the following Table 1.

2. Evaluation of Water Contact Angle

Water was dropped on the surface of the antifouling layer of the hard coating film to measure the water contact angle using a contact angle meter (MSA, KRUSS GmbH).

3. Evaluation of Wear Resistance

A hard coating film was cut into a size of 7 cm×12 cm and fixed to a jig of a wear resistance tester (manufactured by Kipae E&T Co. Ltd.), and steel wool (#0000, Liberon Limited) was provided in and fixed to a tip having a diameter of 22 mm. A moving distance of 100 mm, a moving speed of 60 mm/sec, and a load of 0.5 kg were set, the surface of the antifouling layer of the hard coating film was rubbed with steel wool 2000 times reciprocatively, and the number of flaws (scratches) on the surface was visually observed.

TABLE 1

| | Curl | Water contact | |
|---|---|---|---|
| Classification | amount | angle (°) | Wear resistance |
| Example 1 | 0.5 mm | 111 | 0 |
| Example 2 | 5 mm | 110 | 3 |
| Comparative | 50 mm | 102 | Antifouling layer |
| Example 1 | | | exfoliation |
| Comparative | 3 mm | 103 | >50 |
| Example 2 | | | |
| Comparative | 50 mm | 109 | 5 |
| Example 3 | | | |

Referring to the above Table 1, when a cured layer is formed using an epoxy siloxane resin and then an antifouling layer is formed using a fluorine-substituted silsesquioxane resin according to the exemplary embodiments of the present invention, it was found that an anti-curling property, an antifouling property, and wear resistance are greatly improved.

The hard coating film according to the exemplary embodiments of the present invention includes the cured layer of the composition for forming a hard coating layer including an epoxy siloxane resin and the antifouling layer including a fluorine-substituted silsesquioxane resin. The antifouling layer may secure excellent antifouling performance due to the fluorine-substituted silsesquioxane component. In addition, due to the similar chemical structure of the epoxy siloxane resin and the fluorine-substituted silsesquioxane resin, a chemical bond between the cured layer and the antifouling layer may be formed to improve interlayer bonding force. When the interlayer bonding force is improved, a curling phenomenon of a laminate due to a difference in a shrinkage, an expansion rate, and a modulus of elasticity of each layer may be suppressed.

According to some exemplary embodiments, the cured layer may be formed by ultraviolet-curing and then thermally curing the composition for forming a hard coating layer, and since the ultraviolet-curing and thermal curing are carried out simultaneously, a curing time is shortened and uniform curing may be performed. In addition, partial overcuring phenomenon may be prevented. Accordingly, the cured layer may have improved hardness while maintaining flexibility, and curls of the cured layer may be suppressed.

According to some exemplary embodiments, a silsesquioxane resin having an epoxy group may be used as the epoxy siloxane resin. Thus, bonding force between the cured layer and the antifouling layer including the fluorine-substituted silsesquioxane resin may be further improved.

According to some exemplary embodiments, the composition for forming a hard coating layer may include a thermal initiator of a specific chemical formula. Accordingly, thermal curing may be carried out rapidly at a low temperature, and deformation or damage of the cured layer due to high temperature curing or an increased curing time may be prevented.

What is claimed is:

1. A hard coating film comprising:
a substrate;
a cured layer of a composition for forming a hard coating layer including an epoxy siloxane resin, disposed on the substrate; and
an antifouling layer including a fluorine-substituted silsesquioxane resin, disposed on the cured layer.

2. The hard coating film of claim 1, wherein the epoxy siloxane resin includes a silsesquioxane resin having an epoxy group.

3. The hard coating film of claim 1, wherein the composition for forming a hard coating layer further includes a thermal initiator including a compound represented by the following Chemical Formula 2 and a photoinitiator: 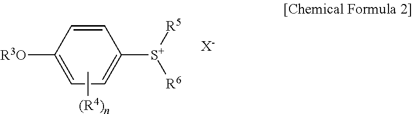
wherein R³ is hydrogen, an alkoxycarbonyl group having 1 to carbon atoms, an alkylcarbonyl group having 1 to 4 carbon atoms, or an arylcarbonyl group having 6 to 14 carbon atoms, R⁴ is independently of each other hydrogen, halogen, or an alkyl group having 1 to 4 carbon atoms, n is 1 to 4, R⁵ is an alkyl group having 1 to 4 carbon atoms or an aralkyl group having 7 to carbon atoms which may be substituted by an alkyl group having 1 to 4 carbon atoms, R⁶ is an alkyl group having 1 to 4 carbon atoms, and X is SbF₆, PF₆, AsF₆, BF₄, CF₃SO₃, N(CF₃SO₂)₂, or N(C₆F₅)₄.

4. The hard coating film of claim 1, wherein the composition for forming a hard coating layer further includes a crosslinking agent including a compound represented by the following Chemical Formula 1: 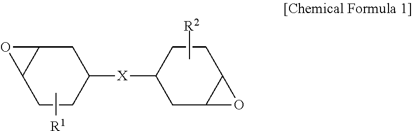
wherein R¹ and R² are independently of each other a linear or branched alkyl group having 1 to 5 carbon atoms, and X is a direct bond; a carbonyl group; a carbonate group; an ether group; a thioether group; an ester group; an amide group; a linear or branched alkylene group, alkylidene group, or alkoxylene group having 1 to 18 carbon atoms; a cycloalkylene group or cycloalkylidene group having 1 to 6 carbon atoms; or a connecting group thereof.

5. The hard coating film of claim 1, wherein the cured layer is a complexly cured layer formed by photocuring and then thermally curing the composition for forming a hard coating layer.

6. A preparation method of a hard coating film, the method comprising:
applying a composition for forming a hard coating layer including an epoxy siloxane resin on a substrate;
curing the applied composition for forming a hard coating layer to form a cured layer;
applying a composition for forming an antifouling layer including a fluorine-substituted silsesquioxane resin on the cured layer; and
curing the applied composition for forming an antifouling layer.

7. The preparation method of a hard coating film of claim 6, wherein the forming of a cured layer is photocuring and then thermally curing the composition for forming a hard coating layer.

8. The preparation method of a hard coating film of claim 7, wherein the thermally curing is carried out at a temperature of 100 to 200° C. for 5 to 20 minutes.

9. The preparation method of a hard coating film of claim 7, further comprising pretreating the composition for forming a hard coating layer by heating before the photocuring.

10. The preparation method of a hard coating film of claim 9, wherein the pretreating is carried out at a lower temperature than the thermal curing temperature.

11. The preparation method of a hard coating film of claim 6, wherein the curing of a composition for forming an antifouling layer is thermally curing the composition at a temperature of 50 to 100° C. for 3 to 30 minutes.

12. The preparation method of a hard coating film of claim 6, wherein the epoxy siloxane resin includes a silsesquioxane resin having an epoxy group.

13. The preparation method of a hard coating film of claim 6, wherein the composition for forming a hard coating layer further includes a thermal initiator including a compound represented by the following Chemical Formula 2 and a photoinitiator: 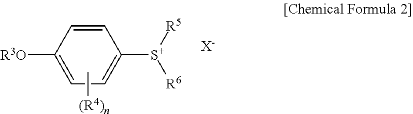
wherein R³ is hydrogen, an alkoxycarbonyl group having 1 to carbon atoms, an alkylcarbonyl group having 1 to 4 carbon atoms, or an arylcarbonyl group having 6 to 14 carbon atoms, R⁴ is independently of each other hydrogen, halogen, or an alkyl group having 1 to 4 carbon atoms, n is 1 to 4, R⁵ is an alkyl group having 1 to 4 carbon atoms or an aralkyl group having 7 to carbon atoms which may be substituted by an alkyl group having 1 to 4 carbon atoms, R⁶ is an alkyl group having 1 to 4 carbon atoms, and X is SbF₆, PF₆, AsF₆, BF₄, CF₃SO₃, N(CF₃SO₂)₂, or N(C₆F₅)₄.

14. The preparation method of a hard coating film of claim 6, wherein the composition for forming a hard coating layer further includes a crosslinking agent including a compound represented by the following Chemical Formula 1: 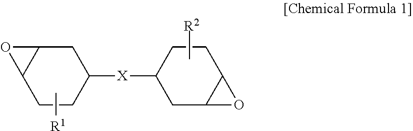
wherein R¹ and R² are independently of each other a linear or branched alkyl group having 1 to 5 carbon atoms, and X is a direct bond; a carbonyl group; a carbonate group; an ether group; a thioether group; an ester group; an amide group; a linear or branched alkylene group, alkylidene group, or alkoxylene group having 1 to 18 carbon atoms; a cycloalkylene group or cycloalkylidene group having 1 to 6 carbon atoms; or a connecting group thereof.
